(19) United States
(12) Patent Application Publication
(10) Pub. No.: US 2003/0034480 A1
(43) Pub. Date: Feb. 20, 2003

(54) Conversion of non-conducting polymers to conducting polymers

(76) Inventor: Bruno M. Vittimberga, Kingston, RI (US)

Correspondence Address: Samuels, Gauthier & Stevens LLP, Suite 3300, 225 Franklin Street, Boston, MA, 02110, US

(21) Appl. No.: 10/192,472

(22) Filed: Jul. 10, 2002

Related U.S. Application Data
(63) Continuation of application No. PCT/US01/00972, filed on Jan. 11, 2001.
(60) Provisional application No. 60/175,516, filed on Jan. 11, 2000.

(51) Int. Cl. H01C 1/00

(52) U.S. Cl. 252/500

(57) ABSTRACT

A polymer system comprised of a plurality of organic aryl molecules dissolved, mixed or blended into a polymer matrix to produce a polymer system. The polymer system is characterized in that subsequent to irradiation it becomes electrically conductive. The conductivity of the polymer system can be controlled by irradiating the polymer system with light at predetermined time intervals.

### CROSS-REFERENCE TO RELATED APPLICATIONS

This application claims the benefit of U.S. Provisional Application No. 60/175,516, filed Jan. 11, 2000.

### BACKGROUND AND BRIEF SUMMARY OF THE INVENTION

This invention relates to the use of a mixture of organic aryl molecules in a polymeric matrix as a photo-responsive material and photo-conductive material. Some organic polymers conduct by electron movement along and between the polymer chains. As the polymer chains increase in length, less energy is required for conductance. It is clear that no chain extends the length of the conducting wire, and therefore, in order for conduction to occur, the electrons must at some point “jump” between chains as it moves toward a less negative potential. The preparation of these conducting polymers can often be difficult, time consuming and expensive. The present invention provides a conducting polymer system, the preparation of which is facile and cost effective.

Broadly, this invention comprises a polymer system comprised of a plurality of organic aryl molecules dissolved, mixed or blended into a polymer matrix to produce a conductive polymer system. The polymer system is characterized in that subsequent to irradiation it becomes electrically conductive. The conductivity of the polymer system can be controlled by irradiating the polymer system with light at predetermined time intervals.

In one aspect of the invention, the polymer system is plated out on a grid and allowed to air dry for a minimum of 48 hours. The grid has silver, or in an alternative embodiment lead-tin on copper, contacts that are attached to an inert plastic and are separated by about 1.0 mm. The resistance of the dried polymer system is used as a measure of its conductance. When the polymer system is irradiated with light in the visible or the ultraviolet spectrum. The dissolved organic aryl molecule absorbs the light and reaches a reactive excited state to which an electron is transferred to the organic aryl molecule from the polymer matrix. Subsequent to irradiation, the organic aryl molecules conduct electricity.

The organic aryl molecules and acceptable salts thereof of the conducting polymer system can include dimethylviologen, 2-quinolinecarbonitrile, 4-cyano-1-methylpyridinium iodide, 2,4-pyridinedicarbonitrile with benzophenone, 1-(1′-ethyl-4′-pyridinyl)-4-pyridonyl chloride, phenanthrene, cyano substituted phenanthrene, phenanthridine, cyano substituted phenanthridines, and viologen with R group substituents such as methyl, ethyl, n-propyl, isopropyl, and benzyl functional groups on the nitrogen atoms.

The organic aryl molecules of the conductive polymer system are characterized in that they have a low reduction potential, a low lying excited state that can be reached by absorbing energy from a light source and can be reduced by electron transfer from suitable donors such as diphenyl ketyl (hydroxydiphenylmethyl radical), amines and most particularly amines having the formula R₃N and phenyl —NR₂, where R_{2,3}=methyl, ethyl, n-propyl, isopropyl, and benzyl functional groups.

When the organic aryl molecules of the conductive polymer system comprise dimethylviologen or 2, 4-pyridinedicarbonitrile suitable electron donors can include alcohols such as methanol, ethanol and 2-propanol.

Preferably, the present invention involves the use of polymers that have alcohol or ether functional groups to serve as a polymeric matrix for the photo-sensitive organic aryl molecules. The electron transfer between the organic aryl molecules and the polymeric matrix results in electrical conductivity of the polymer.

The polymer matrix of the conductive polymer system can include poly(vinyl alcohol) or any other polymers known in the art which can dissolve the aryl organic molecules such as poly(vinylacetate-co-vinylalcohol), cellulose, poly(methylvinyl ether), epoxy resin, and other polymers with alcohol (—OH) and/or ether (—OR) functional groups. In cases in which the polymer matrix is not an electron donor, the polymer matrix must also dissolve the electron donor molecules. In such cases, the polymer matrix can comprise polyalkylmethacrylate, polyacrylate, polyvinylpyrrolidone or polyethylenimine.

In one aspect of the invention, the organic aryl molecules comprise about 15-40% by weight based upon the total weight of the conducting polymer system.

In certain polymeric matrices, a sensitizer such as benzophenone can be added to serve either as a photosensitizer or a chemical sensitizer by electron transfer from the photochemically generated ketyl of benzophenone. Other suitable sensitizers can include aryl ketones, substituted aryl ketones such as 4,4′-dimethylbenzophenone and 4,4′-dipyridinal ketone, acetophenone and substituted acetophenone.

The invention also comprises a method for converting a nonconductive polymer to a conductive polymer system which comprises dissolving a plurality of organic aryl molecules in a polymer matrix to form a polymer system and irradiating the polymer system with light. The irradiated organic aryl molecules reach an excited state thereby effecting the transfer of electrons from the matrix polymer to the aryl molecules.

In another aspect of the invention, the method further comprises dissolving organic aryl molecules in a polymer matrix to produce a polymer system having a concentration of about 15-40% organic aryl molecules by weight based upon the total weight of the polymer system.

The conducting polymer systems of the invention can be used in the manufacture of electro-photographic imaging films, photo-voltaic films, and large-area solar energy collectors.

### BRIEF DESCRIPTION OF THE DRAWING(S)

FIG. 1 is a first graph depicting the conductance as a function of time of an irradiated polymer system of the invention comprised of dimethylviologen and poly(vinyl alcohol) wherein the polymer system is irradiated with a sun lamp at full power.

FIG. 2 is a graph depicting the conductance as function of distance of an irradiated polymer system of the invention comprised of dimethylviologen and poly(vinyl alcohol).

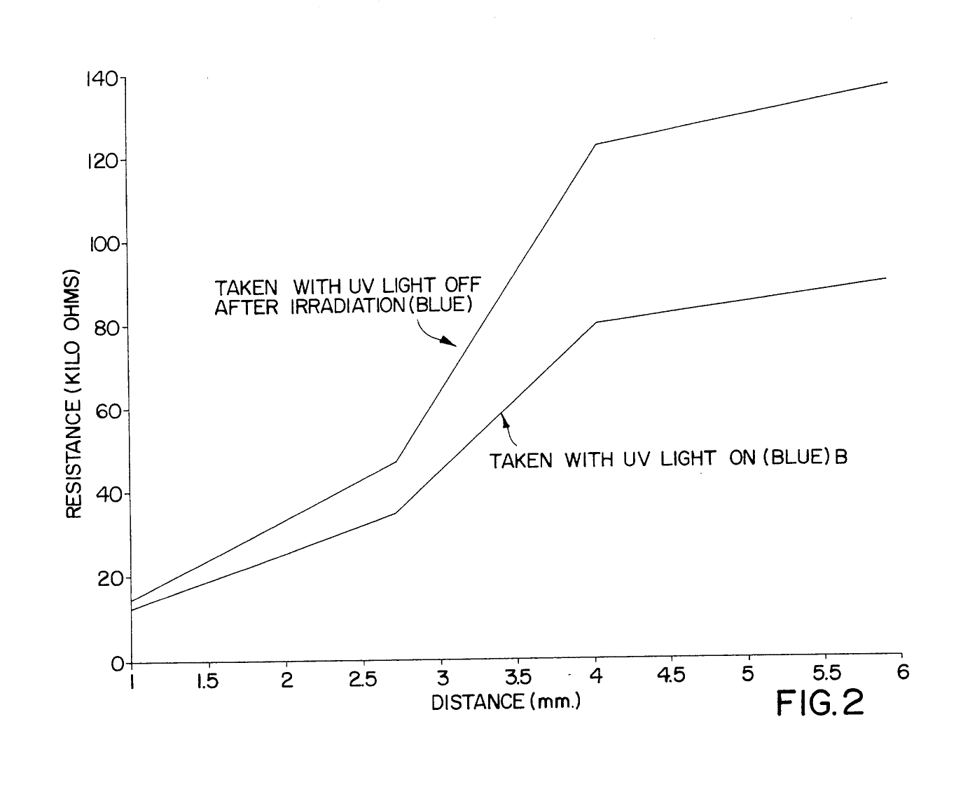

FIG. 3 is a second graph depicting conductance as a function of time of an irradiated polymer system of the invention comprised of dimethyl viologen and poly(vinyl alcohol) wherein the polymer system is irradiated with a sun lamp at fill power.

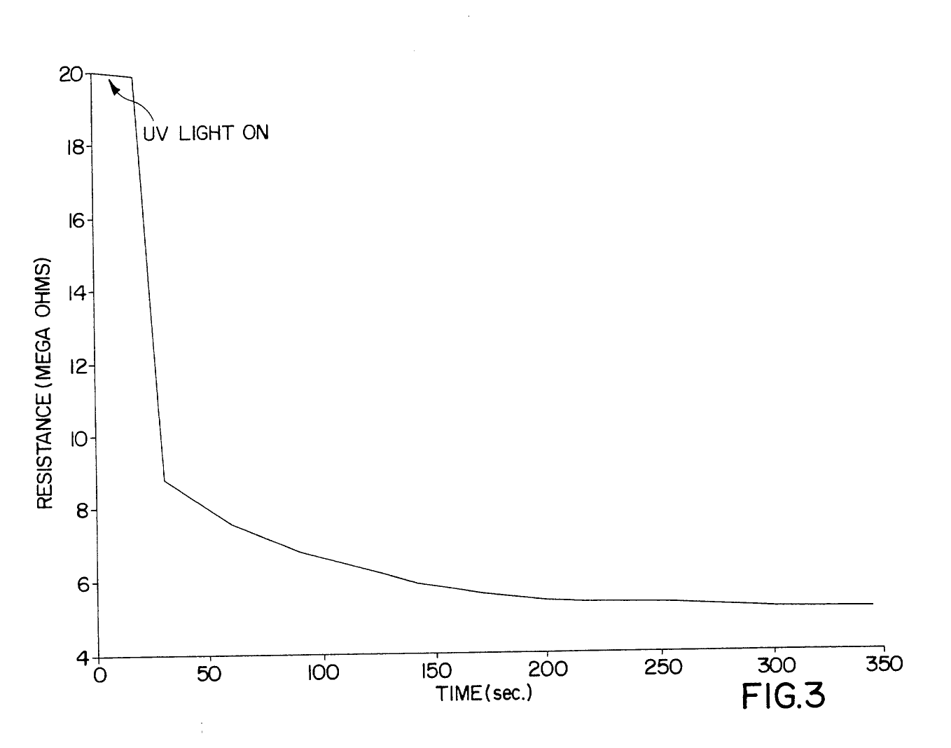

FIG. 4 is a graph depicting the effect of light intensity on the initial rate of decrease of resistance of an irradiated polymer system of the invention.

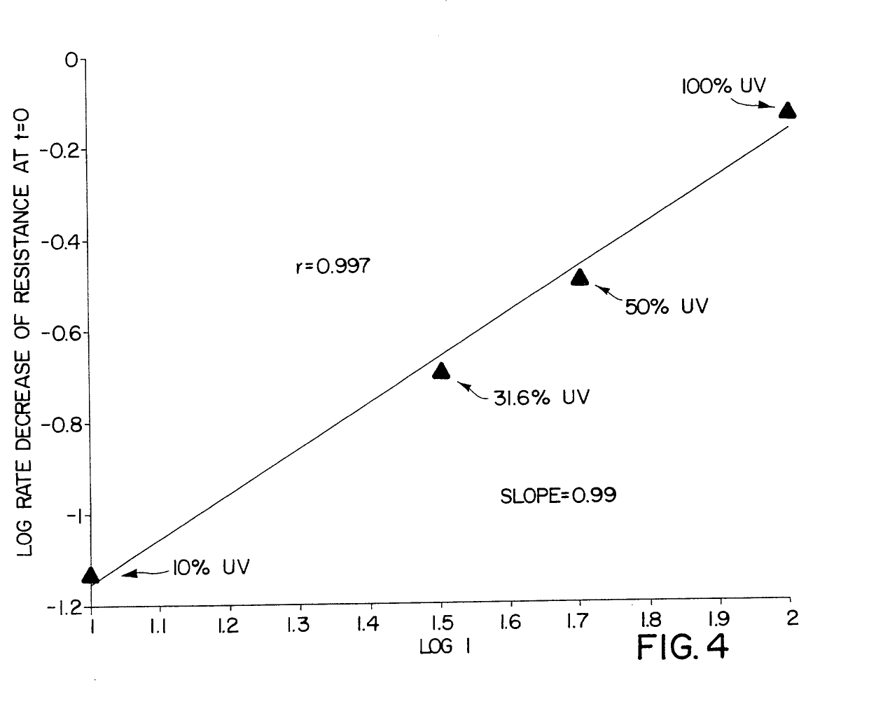

FIG. 5 is a third graph depicting the conductance as a function of time of an irradiated polymer system of the invention comprised of dimethylviologen and poly(vinyl alcohol) wherein the polymer has been irradiated with a sun lamp at full power.

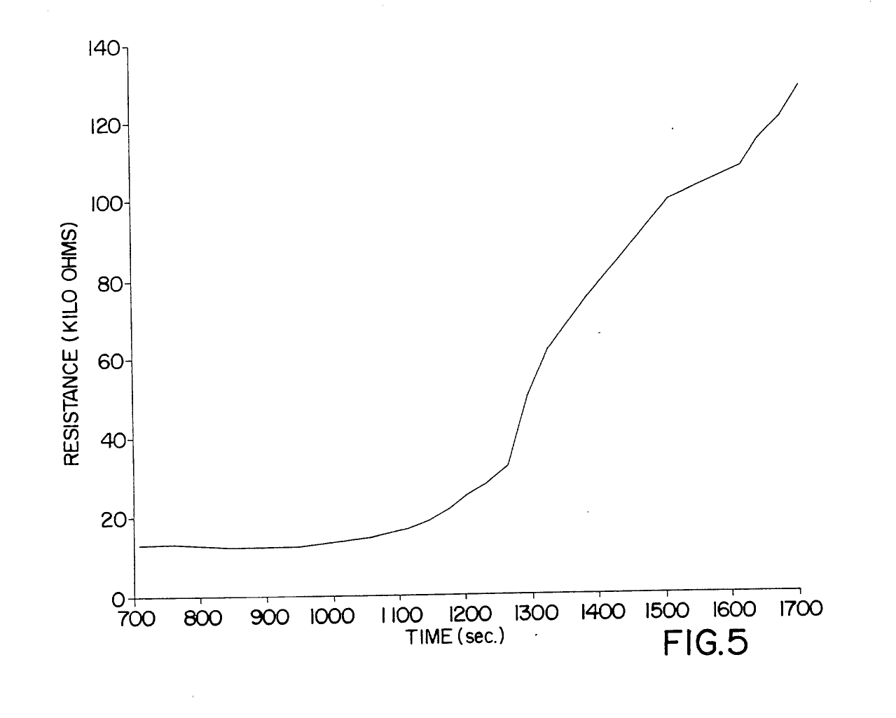

FIG. 6 is a fourth graph depicting the conductance as a function of time of an irradiated polymer system of the invention comprised of dimethylviologen and poly(vinyl alcohol) wherein the polymer has been irradiated with a sun lamp at full power.

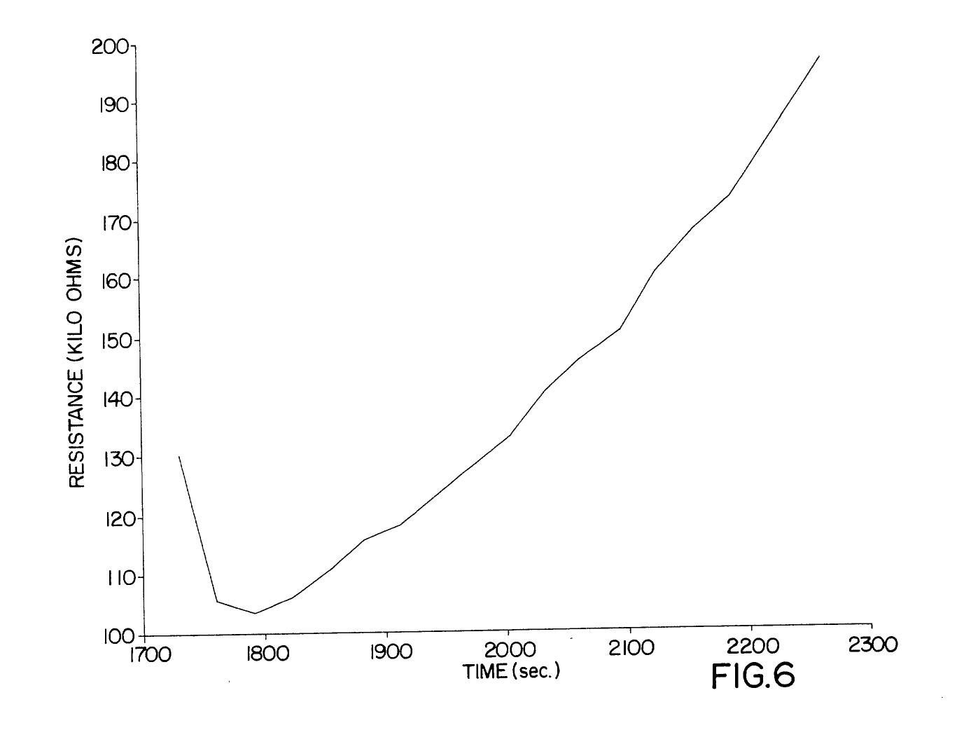

FIG. 7 is a graph depicting the conductance as a function of time of an irradiated polymer system of the invention comprised of dimethylviologen and poly(vinyl alcohol) wherein the polymer has been irradiated with a sun lamp at reduced power.

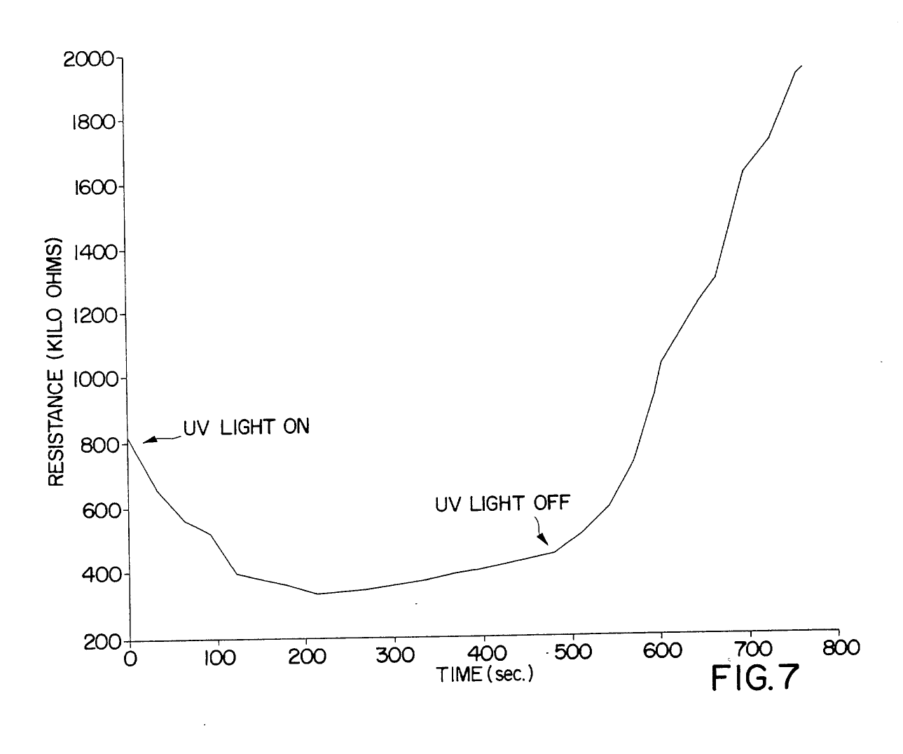

FIG. 8 is a graph depicting the conductance as a function of time of an irradiated polymer system of the invention comprised of 2,4-Pyridinedicarbonitrile with benzophenone and poly(vinyl alcohol).

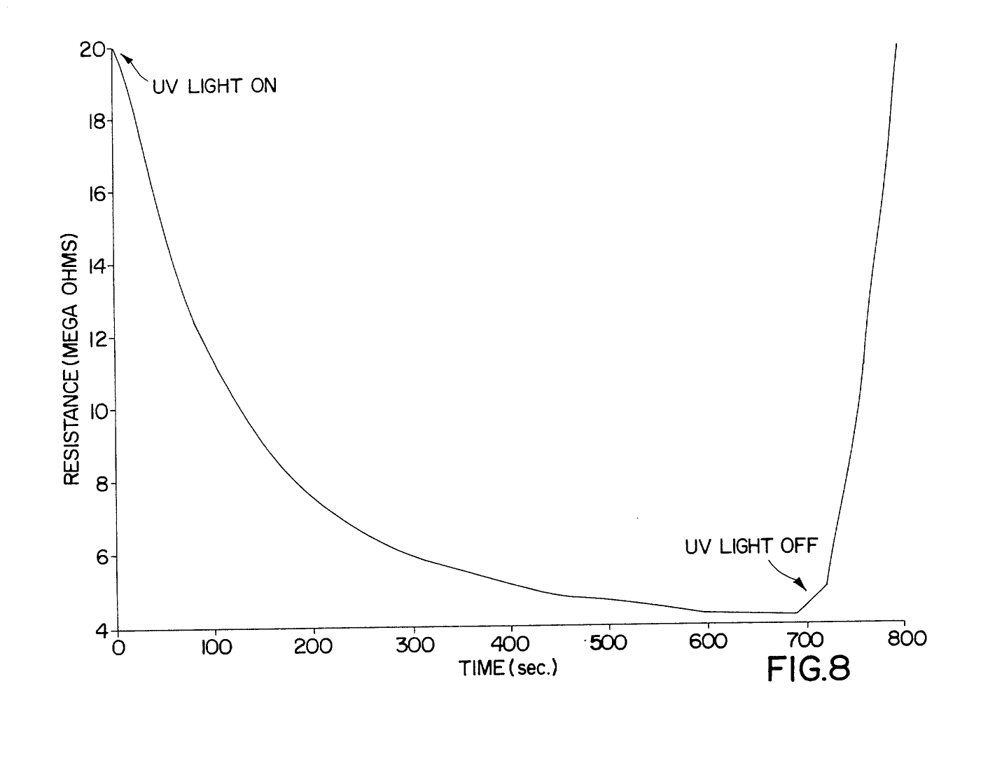

FIG. 9 is a graph depicting the conductance as a function of time of an irradiated polymer system of the invention comprised of 1-(1′ethyl-4′-pyridinyl)-4-pyridonyl chloride with benzophenone and poly(vinyl alcohol).

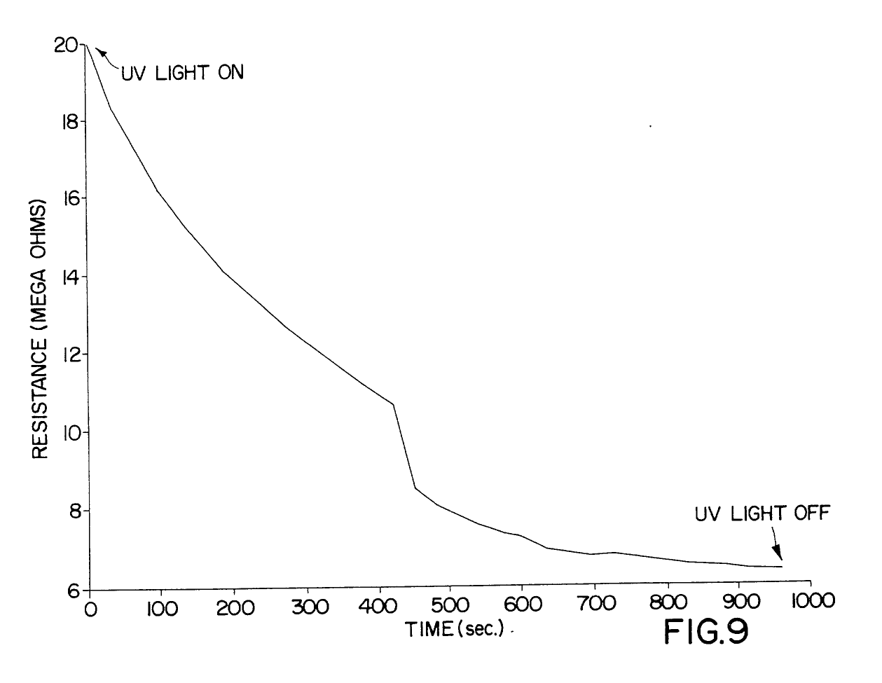

FIG. 10 is a graph depicting the conductance as a function of time of an irradiated polymer system of the invention comprised of Phenanthrene with benzophenone and poly(vinyl alcohol).

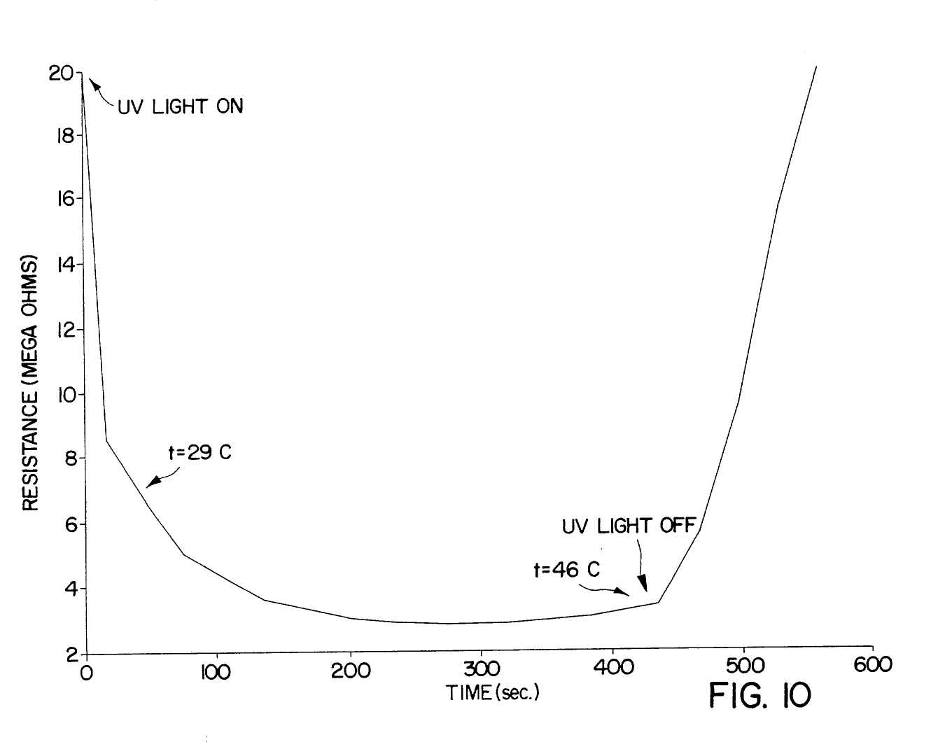

### DESCRIPTION OF THE PREFERRED EMBODIMENT(S)

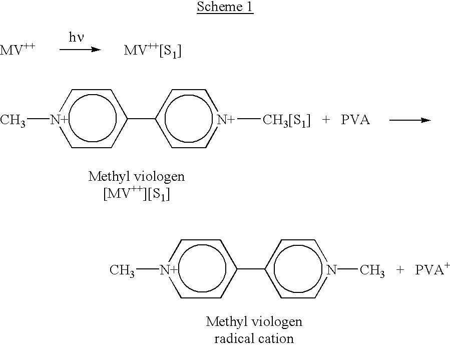

Scheme 1 illustrate the photo-excitation and the subsequent electron transfer reaction for dimethyl viologen imbedded in a poly(vinyl alcohol) matrix. In the equation, MV⁺⁺ is used as a symbol for methyl viologen dication. The dication can be derived from its chloride salt with chemical name of 1,1′-dimethyl-4,4′-bipyridinium dichloride. The symbol [S₁] stands for the first excited singlet state of the viologen dication. The first equation is the absorption of a ultra-violet photon to convert the ground state methyl viologen to its first excited singlet state. The second equation indicates that an electron is transferred from the poly(vinyl alcohol), or PVA, to methyl viologen to form a single-charged methyl viologen radical cation.

In a particularly preferred embodiment and referring to scheme 1, the conductive polymer system comprises dimethyl viologen molecules dissolved in an aqueous solution of poly(vinyl alcohol) to form a polymer system. The polymer system is dried on a grid. The grid has parallel contacts made of lead-tin on copper that are attached to an inert plastic and are separated by about 1.0 mm. The resistance of the dried polymer system was used as a measure of its conductance. When the polymer system is irradiated with a light having wavelengths in the range of about 300 nm to 400 nm the dimethyl viologen molecule absorbs the light and reaches a reactive excited state to which an electron is transferred from poly(vinyl alcohol).

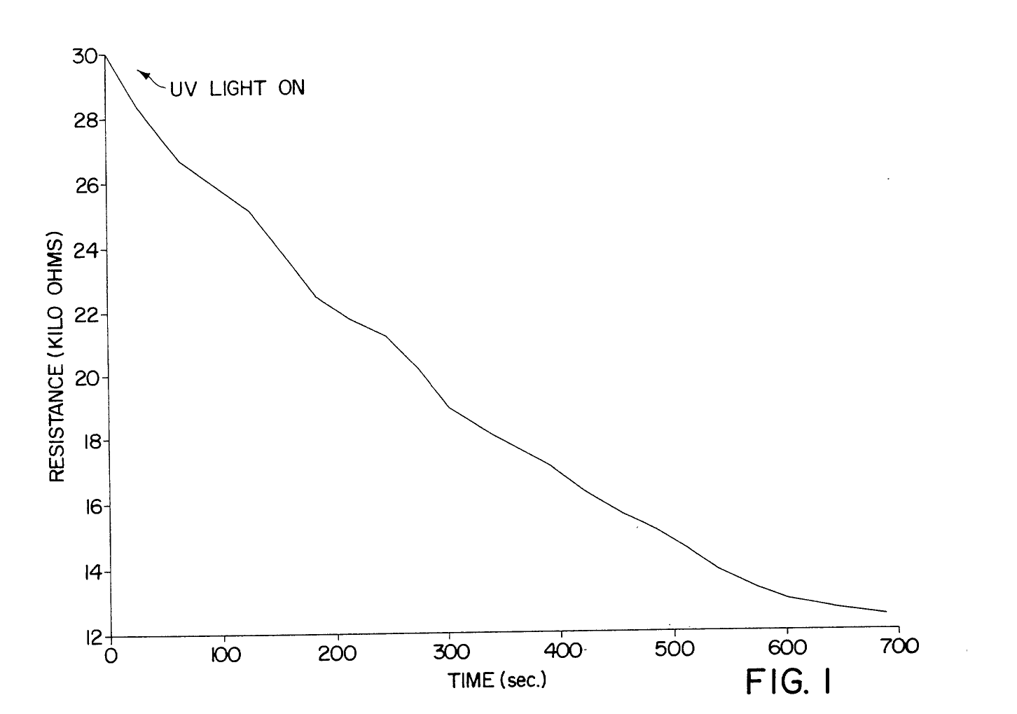

Referring to FIG. 1, at the beginning of the irradiation period, there is no color and no conductance is observed. Shortly after irradiation begins, a blue color begins to form and the resistance of the polymer system decreases. When the dried polymer system has been irradiated for less than 6 minutes the resistance decreases further. When the irradiation ceases, the resistance increases. At this point, the dimethyl viologen molecule is a photoconductor. As the dried polymer system is irradiated again, the steady state concentration of the methyl viologen radical cation increases as was indicated by the intensity of the blue color. When the plastic is intensely blue with these radial ions, then the dried polymer system is highly conducting whether the light is on or off. The dried polymer system has now become a conductor. Blue samples have conducted for 9 months without further irradiation. The stability of the dimethyl viologen radical cation is determined by the thickness of the plastic because the radicals are usually destroyed by air. Accordingly, thicker polymer films provide a more effective barrier to the diffusion of air into plastic.

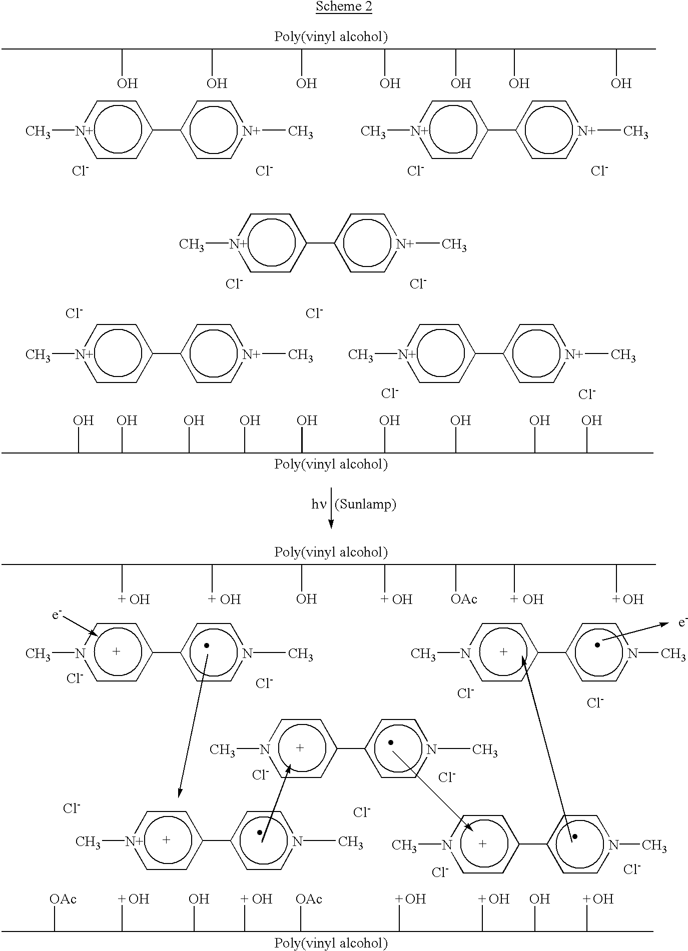

Referring to Scheme 2, when a current is passed through the irradiated polymer system, electrons “hop” from molecule to molecule, each time producing the same cation radical that it left.

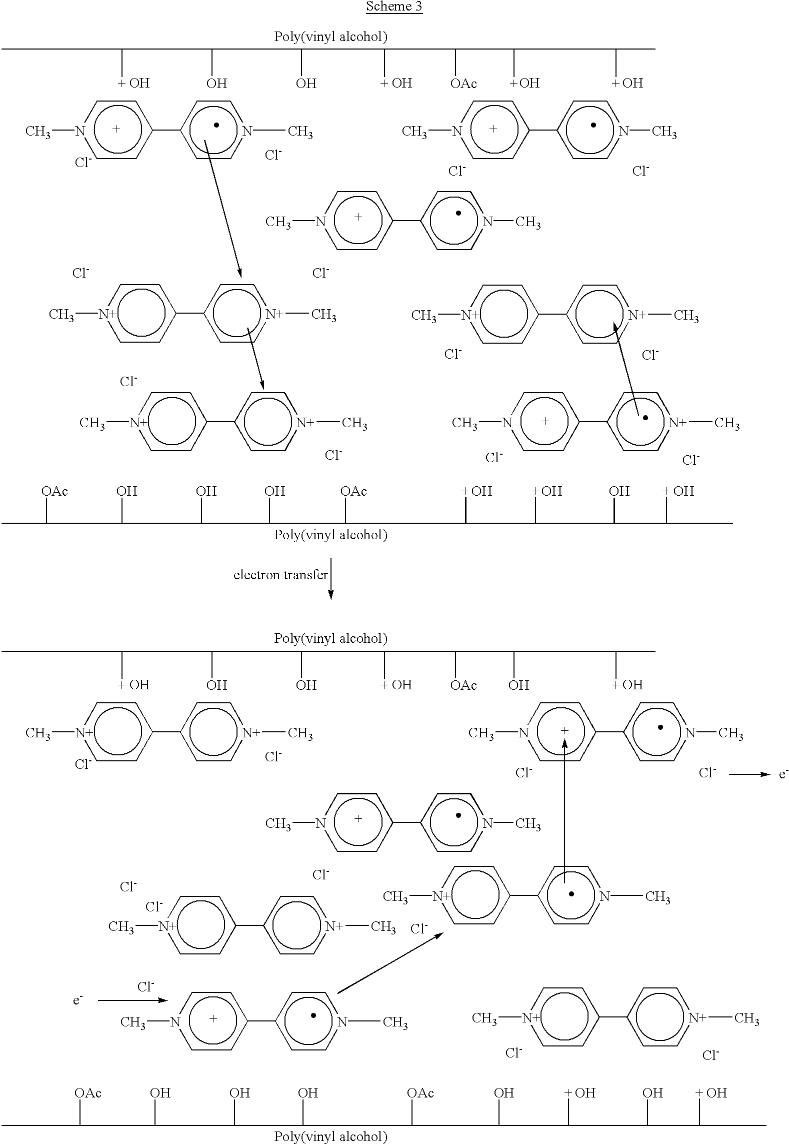

Referring to Schemes 2 and 3, the chlorides are the counter ions of MV⁺⁺ Referring to Scheme 3, when a radical cation transfers an electron to an unreacted dimethyl viologen molecule which does not have an oxonium ion to which it can transfer an electron, then the acceptor molecule will become a stable long lived radical cation and conduct with the light on or off.

Regarding, the mechanism of conductance for the dimethyl viologen radical cation, either ring can be written as a radical or cation. This means both rings have the character of both cation and radical. An electron can be transferred into either ring and out the other to a second molecule without changing the electronic character of the donor molecule. When this process has been repeated many times, the overlapping molecules have become a wire.

The invention will further be described with reference to following non-limiting examples.

### EXAMPLE 1

0.08 g of methyl viologen was used with 0.5 g of poly(vinyl alcohol). This concentration of reactants corresponds to a ratio of moles OH units to moles of dimethyl viologen of 24:5. After nine months, an intensely blue sample conducted with a resistance of 6500 ohms without irradiation. When this sample was irradiated, the resistance dropped to 3450 ohms.

Results

The best conductance is exhibited by the conducting polymer systems comprised of dimethyl viologen and poly(vinyl alcohol). Dimethyl viologen dissolved in aqueous poly(vinyl alcohol) form dimethyl cation radicals having an intense blue color. At the beginning of the irradiation period, there is no color and no conductance is observed. However, a very few seconds after the light is turned on, color starts to form and the resistance begins to drop, indicating an increase in conductance. If at any point in time the light is turned off, the resistance increases somewhat, but the plastic continues to conduct with the light on or off as long as the plastic remains colored. This indicates that the radical plays a fundamental role in the conduction process.

The conducting polymer systems of the invention can be used to replace the conducting plastics in existing equipment such as photocopiers, laser printers and fax machines.

The foregoing description has been limited to a specific embodiment of the invention. It will be apparent, however, that variations and modifications can be made to the invention, with the attainment of some or all of the advantages of the invention. Therefore, it is the object of the appended claims to cover all such variations and modifications as come within the true spirit and scope of the invention.

Having described our invention, what I now claim is:

1. A conductive polymer system comprising:
organic aryl molecules within an electron donating matrix, the polymer system being conductive when irradiated.

2. The conductive polymer system according to claim 1 wherein the organic aryl molecules are selected from the group consisting of dimethylviologen, 2-quinolinecarbonitrile and 4-cyano-1-methylpyridinium iodide.

3. The conductive polymer system according to claim 1 wherein the polymer matrix is selected from the group consisting of poly (vinyl alcohol), poly(vinylacetate-co-vinylalcohol), cellulose, poly(methylvinyl ether), epoxy resin, and other polymers with alcohol (—OH) and/or ether (—OR) functional groups.

4. The conductive polymer system according to claim 1 wherein the system further comprises sensitizers selected from the group consisting benzophenone, aryl ketones, substituted aryl ketones such as 4,4′-dimethylbenzophenone and 4,4′-dipyridinal ketone, acetophenone and substituted acetophenone.

5. The polymer system according to claim 1 wherein the organic aryl molecules comprise about 15-40% by weight based upon the total weight of the conductive polymer system.

6. A method for converting a nonconductive polymer to a conductive polymer which comprises:
dissolving a plurality of organic aryl molecules in a polymer matrix to form a polymer system; and
irradiating the polymer system with light to effect the transfer of electrons from the matrix polymer to the aryl molecules.

7. The method according to claim 6 wherein the polymer system is irradiated for less than 6 minutes.

8. The method according to claim 6 wherein the light has a wavelength in the range of about 300 to 400 nm.

9. The method according to claim 6 wherein the organic aryl molecules are selected from the group consisting of dimethylviologen, 2-quinolinecarbonitrile and 4-cyano-1-methylpyridinium iodide.

10. The method according to claim 6 wherein the polymer matrix is selected from the group consisting of poly (vinyl alcohol), poly(vinylacetate-co-vinylalcohol), cellulose, poly(methylvinyl ether), epoxy resin, and other polymers with alcohol (—OH) and/or ether (—OR) functional groups.

11. The method according to claim 6 which further comprises adding a sensitizer selected from the group consisting benzophenone, aryl ketones, substituted aryl ketones such as 4,4′-dimethylbenzophenone and 4,4′-dipyridinal ketone, acetophenone and substituted acetophenone to the polymer matrix.
